(19) United States
(12) Patent Application Publication
(10) Pub. No.: US 2018/0004904 A1
(43) Pub. Date: Jan. 4, 2018

(54) SYSTEMS AND METHODS FOR CLINICAL DECISION SUPPORT AND DOCUMENTATION

(71) Applicant: QualDocs Medical, LLC, Edmonds, WA (US)

(72) Inventor: Richard C. PHILLIPS, Edmonds, WA (US)

(21) Appl. No.: 15/520,806

(22) PCT Filed: Oct. 23, 2015
(86) PCT No.: PCT/US2015/057174

§ 371 Date: Apr. 20, 2017

Related U.S. Application Data
(60) Provisional application No. 62/068,408, filed on Oct. 24, 2014.

(51) Int. Cl. G06F 19/00; G06F 17/30

(52) U.S. Cl. CPC G06F 19/345; G06F 19/3487; G06F 19/3431; G06F 17/30864; G06F 19/3406; G06F 19/322; G06F 19/3437

(57) ABSTRACT

Various implementations of methods and systems for computing a patient-specific medical report associated with a diagnosis and generating supporting documentation for the report are described in this disclosure. In some implementations, the medical documentation system can assist doctors in providing care to hospitalized patients. In some implementations, the medical documentation system can generate a patient-specific appeal letter in response to a medical claim denial. Results of patient data input into evidence-based models can be presented to a user thorough a graphical user interface (GUI), which can also allow the user to interact with the medical documentation system. In some implementations, the medical documentation system can generate an interactive graphical user interface (GUI) that can be used to analyze patient data.

### CROSS REFERENCE TO RELATED APPLICATION

This application claims priority to and benefit from U.S. Provisional Patent Application No. 62/068,408 entitled “SYSTEMS AND METHODS FOR CLINICAL DECISION SUPPORT AND DOCUMENTATION,” filed on Oct. 24, 2014, the content of which is hereby incorporated by reference herein in its entirety for all purposes.

### TECHNICAL FIELD

Various implementations of the present disclosure generally relate to generating supplemental information for medical decisions. More specifically, some implementations of the present disclosure relate to methods and systems for computing a patient-specific medical report associated with a diagnosis and generating supporting documentation for the medical report.

### BACKGROUND

Current hospital and medical care systems for patients are dependent on conventional Electronic Health Records (EHR)/Electronic Medical Records (EMR) database systems. EHR and EMR database systems provide standardized data templates for patients. Standardized data templates enable doctors and administrators to view medical and demographic information for a particular patient. For example, a hospital administrator can view a patient's age, weight, height, and notes from a doctor regarding the patient's most recent visit. However, the templates are rigid, not interactive, and do not provide additional information beyond what is in a patient's record.

Also, EHR and EMR serve as evidence for hospitals, healthcare systems, and medical care providers in the billing process. For example, Medicare and health insurance companies increasingly deny medical claims or enforce penalties based on lack of or insufficient evidence found in the EHR in support of clinical decisions for both inpatient and outpatient medical care. In response to denials or penalties, hospital administrators are forced to review the EHR and find supporting arguments to rebut the denials or penalties, which is a time consuming and arduous process. Hospital administrators prefer to spend time managing the hospital as compared to reviewing denied claims.

The need exists for systems and methods that overcome the above problems as well as provide additional benefits. Other limitations of existing or prior systems will become apparent to those of skill in the art upon reading the following Detailed Description.

### SUMMARY

Various implementations of methods and systems for computing a patient-specific medical report associated with a diagnosis and generating supporting documentation for the report are described in this disclosure. In some implementations, a method for processing medical data and generating a patient-specific risk assessment for a medical diagnosis is provided. In some embodiments, the method can include receiving, via a graphical user interface on an electronic device, a selection for a patient. In response to receiving the selection for the patient, electronic medical record data for the patient can be automatically retrieved. A diagnosis for the patient can be received via the graphical user interface. Statistical medical models can be identified that correspond with the diagnosis, and based on the diagnosis, the electronic medical record data, and the statistical medical models, a list of risk variables can be generated. At least some values may be associated the risk variables. Based on the values, an outcome can be computed for at least some of the statistical medical models using the values associated with the risk variables. An instruction to generate a patient-specific risk assessment can be received. Then, based on the risk variables and the at least some values associated with the risk variables, the patient-specific medical risk assessment can be generated. The assessment can include: predictive medical information, expected length of stay, and risk of readmission for the patient.

Implementations of the present disclosure also include computer-readable storage media containing sets of instructions to cause one or more processors to perform the methods, variations of the methods, and other operations described herein.

While multiple implementations are disclosed, still other implementations of the present disclosure will become apparent to those skilled in the art from the following detailed description, which shows and describes illustrative implementations of the disclosure. As will be realized, the disclosure is capable of modifications in various aspects, all without departing from the scope of the present disclosure. Accordingly, the drawings and detailed description are to be regarded as illustrative in nature and not restrictive.

### BRIEF DESCRIPTION OF THE DRAWINGS

These and other objects, features, and characteristics will become more apparent to those skilled in the art from a study of the following Detailed Description in conjunction with the appended claims and drawings, all of which form a part of this specification. While the accompanying drawings include illustrations of various embodiments, the drawings are not intended to limit the claimed subject matter.

FIG. 1 is a generalized block diagram depicting certain components in a medical documentation system in accordance with some implementations of the present disclosure.

FIG. 2 is a generalized block diagram illustrating a medical documentation platform in accordance with some implementations of the present disclosure.

FIG. 3 is a flow diagram illustrating an example of a set of operations for generating a care-specific risk profile assessment in accordance with some implementations of the present disclosure.

FIG. 4 is a flow diagram illustrating an overview of a process for generating a medical report based on predictive models in accordance with some implementations of the present disclosure.

FIGS. 5-8 are screenshots of graphical user interfaces (GUIs) in accordance with some implementations of the present disclosure.

FIG. 9 and FIG. 10 are an example of a letter generated by the medical documentation platform in accordance with some implementations of the present disclosure.

FIG. 11 is a block diagram illustrating an example of a computing system in which at least some operations described herein can be implemented.

The drawings have not been drawn to scale. For example, the dimensions of some of the elements in the figures may be expanded or reduced to help improve the understanding of the implementations of the present disclosure. Similarly, some components and/or operations may be separated into different blocks or combined into a single block for the purposes of discussion of some of the implementations of the present disclosure. Moreover, while the disclosure is amenable to various modifications and alternative forms, specific implementations have been shown by way of example in the drawings and are described in detail below. The intention, however, is not to limit the disclosure to the particular implementations described. On the contrary, the disclosure is intended to cover all modifications, equivalents, and alternatives falling within the scope of the disclosure as defined by the appended claims.

### DETAILED DESCRIPTION

The present disclosure relates to methods and systems that use evidence-based models and medical literature to generate a patient-specific medical report (also referred to as “the medical documentation system” approach). For example, a hospital administrator can use the medical documentation system to generate a report that includes a prediction for the length of hospital stay for a patient who had a heart attack prior to a hospital visit. In such an example, the medical documentation system automatically computes a prediction for length of stay based on the patient's electronic medical records (e.g., age, hypertension, race, blood pressure, daily aspirin dosage, etc.), evidence-based medical models for heart attacks (e.g., a statistical model for prediction of acute coronary syndrome involving 10,000 patients, the IMPROVE Heart Failure statistical model), and medical literature (e.g., American College of Cardiology and Society Thoracic Surgeon registries). In some embodiments, the patient-specific medical report can include other information such as probability of mortality for the patient or likelihood of post-discharge events (e.g., another heart attack, chest pain, etc.).

In some implementations, the medical documentation system can assist doctors in providing care to hospitalized patients. For example, an emergency room doctor can use the medical documentation system to predict post-discharge events for a patient experiencing chest pain (e.g., readmission to the hospital for chest pain, heart attack within three weeks of visit, or likelihood of mortality within three months). The doctor can use the likelihood of post-discharge events to recommend a plan for care. Furthermore, a hospital administrator or doctor can use the medical documentation system to update or revise predictions in real time (e.g., when the patient is in a hospital bed). For example, a lab assistant can input cholesterol data into an electronic medical record for a patient who is experiencing chest pain, and the medical documentation system can automatically update the post-discharge prediction as the doctor reviews the prediction information in an emergency room.

In some implementations, the medical documentation system can generate a patient-specific appeal letter in response to a medical claim denial. For example, a hospital administrator may receive a notice that an insurance company denied coverage for a medical claim for a patient that was recently admitted to a hospital because the patient stayed for too long at the hospital following a heart attack. In response, the hospital administrator can request that the medical documentation system generate a letter to appeal the denial. The medical documentation system can generate a letter incorporating medical models, evidence-based literature, and data from a patient's electronic medical record that support the patient's length of stay. For example, the medical documentation system can generate a letter stating that based on a patient's age, hypertension, cholesterol levels, and race, there was a 95% probability that the patient would have another heart attack within a few days, suggesting the patient should stay at the hospital or receive a certain level of care. The letter can include sections and quotes from literature bolstering the prediction (e.g., “based on the Macarthur study, which included 95,000 patients who experienced heart attack, individuals over 82 years of age who are white and have high cholesterol have a 95% chance of returning to a hospital within 24 hours after experiencing heart attack.”). In some implementations, the medical documentation system can include several portions of supporting literature or the results of several medical models.

In some implementations, the medical documentation system can generate an interactive graphical user interface (GUI) that can be used to analyze patient data. For example, via the interactive GUI, a hospital administrator can select to view a patient's medical history and available medical data. The hospital administrator can then select a diagnosis for the patient. For example, the hospital administrator may notice a doctor recently diagnosed the patient with a heart attack, and the hospital administrator can select to view predictive models related to the heart attack diagnosis. In response to a selection for a particular diagnosis for a patient, the GUI can display the variables (e.g., age, blood pressure, gender, race, cholesterol) and corresponding patient values associated with models used to create a prediction for the level of care for the patient. The GUI can also display the relative importance of variables (e.g., a tier 1 variable can be age, which is a strong predictor of outcome in a model compared to gender, a tier 3 variable in a model). The GUI can also display different types of models used in the predicative analysis. The GUI can be configured to be presented by a web application or web-based portal, web browser, or a mobile application adapted for a cellular device, personal digital assistant (PDA), tablet, personal computer, etc.

In some implementations, the medical documentation system can generate clinical documentation for compliance with medical regulations to support hospitals. For example, the Affordable Care Act (ACA) includes provisions to reduce hospital re-admissions. As part of the ACA, hospitals must meet 30-day re-admission measures for heart attack, heart failure, and pneumonia for patients with Medicare. The medical documentation system can track compliance with medical regulations such as the ACA for each patient and present this information to hospital members (e.g., administrators, doctors, nurses, etc.).

The disclosed technology has several advantages. First, healthcare providers and doctors can use the disclosed technology to generate real-time predictive information for a patient's diagnosis. Second, the disclosed technology can create patient-specific predictions based on evidence-based medical models and data from a patient's electronic medical record. Third, the disclosed technology can increase (e.g., improve) a hospital's ability to comply with medical rules and regulations because the technology incorporates rules and regulations into its databases. Fourth, the disclosed technology can help doctors and hospital administrators automatically mitigate claim denials because the disclosed technology can generate letters with clinical evidence to rebut denials. Fifth, the disclosed technology generates an interactive analytic tool that improves upon the standard EHR/EMR template. Sixth, the disclosed technology closes the logical and physical separation between hospitals, doctors, medical literature, evidence-based models, insurance and/or government organizations, and medical record databases through which medical claims and diagnosis are distributed. Seventh, one with ordinary skill in the art can appreciate that the disclosed implementation enables a single party (e.g., a nurse, a doctor, or an insurance company) to obtain information necessary to validate payment for a medical claim. After reading this disclosure, other advantages will be apparent to individuals having ordinary skill in the art.

In the following description, for the purposes of explanation, numerous specific details are set forth in order to provide a thorough understanding of implementations of the present disclosure. It will be apparent, however, to one skilled in the art that implementations of the present disclosure may be practiced without some of these specific details.

Moreover, the techniques introduced here can be embodied as special-purpose hardware (e.g., circuitry), as programmable circuitry appropriately programmed with software and/or firmware, or as a combination of special-purpose and programmable circuitry. Hence, implementations may include a machine-readable medium having stored thereon instructions that may be used to program a computer (or other electronic devices) to perform a process. The machine-readable medium may include, but is not limited to, floppy diskettes, optical discs, compact disc read-only memories (CD-ROMs), magneto-optical discs, ROMs, random access memories (RAMs), erasable programmable read-only memories (EPROMs), electrically erasable programmable read-only memories (EEPROMs), application-specific integrated circuits (ASICs), magnetic or optical cards, flash memory, or other type of media/machine-readable medium suitable for storing electronic instructions.

### Illustrative Environment

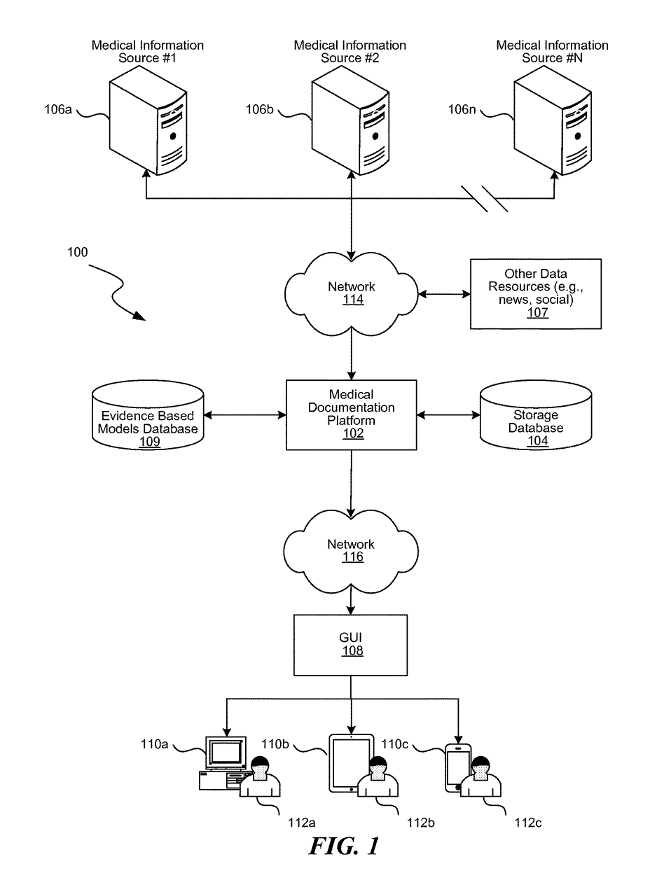

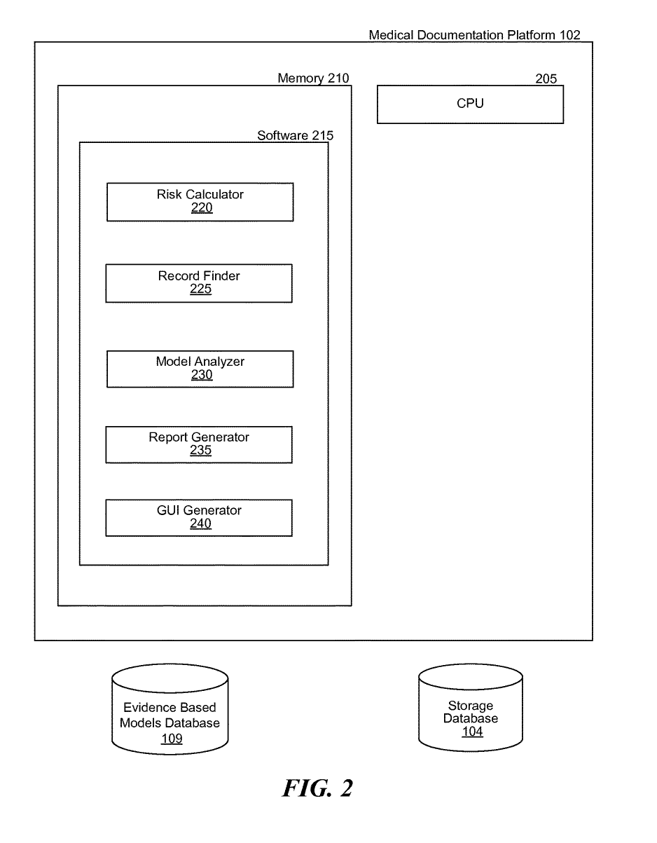

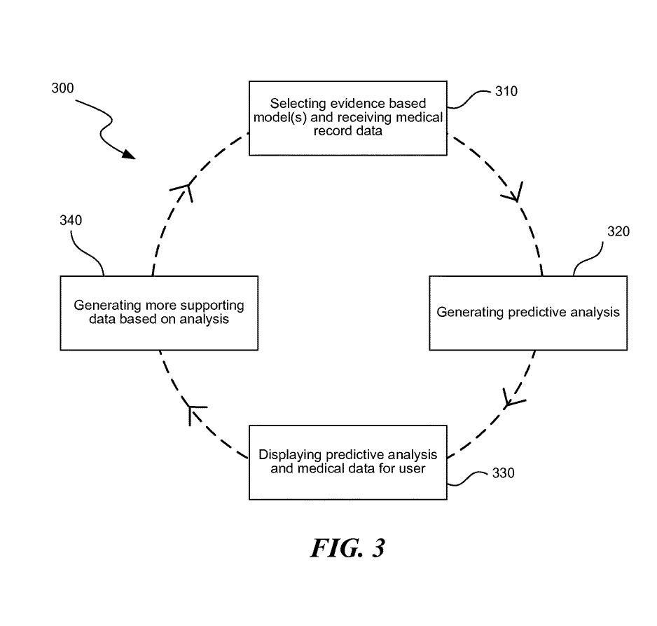

FIG. 1 is a generalized block diagram depicting certain components in a medical documentation system in accordance with some implementations of the present disclosure. A medical documentation system 100 can access and retrieve medical data from one or more sources of medical information 106a-n. The medical data, or some portion the data, can be stored in a storage database 104. Evidence-based models and risk variables can be stored in evidence based models database 109 (evidence-based models and variables are described in more detail in FIGS. 2 and 3). In some embodiments, the medical documentation system 100 accesses the source(s) of medical information 106a-n over a network 114 (e.g., Internet, a local area network, a wide area network, a point-to-point dial-up connection). The source(s) of medical information 106a-n can be, for example, electronic medical records (EMR), electronic health records (EHR), or government databases with health rules, regulations, and data. Other network-accessible databases, such as SQL databases that comply with HIPAA, can also be accessed in certain embodiments.

In some embodiments, the medical documentation system 100 retrieves medical data from more than one source. For example, the medical documentation system 100 can access EHR to obtain health records for a patient. Data may also be retrieved from other resources 107, such as news feeds, social media, conventional search engines, etc. The data can supplement any data retrieved from the source(s) of medical information 106a-n and be used to acknowledge recent events associated with a particular hospital, patient, nurse, doctor, region of the world, etc. A user can review the recent events (e.g., a new study that presents data on heart failure) to identify an appropriate next step or supplement information in a medical form. Source(s) of medical information 106a-n can also include medical compliance information. For example, 106a can be a Hospital Compare database provided by Medicare, which can provide hospitals with data for basic standards of care. Data from a Hospital Compare databased can serve a means for denying or rebutting a medical insurance or Medicare claim.

A user, such as users 112a-c, may interact with the medical documentation system 100 via a graphical user interface (GUI) 108 displayed on one or more electronic devices 110a-c. Users may be doctors, government officials, hospital administrators, nurses, billing companies, insurance companies, and other medical-related personnel. The electronic devices 110a-c may be, for example, mobile phones, PDAs, tablets (e.g., IPAD®), personal computers, or wearable devices (e.g., watches). Electronic devices 110a-c can present a GUI 108 for receiving user inputs, displaying results of statistical analyses, etc. In some embodiments, the electronic devices 110a-c communicate with the medical documentation system 100 over a network 116 (e.g., Internet, a local area network, a wide area network, a point-to-point dial-up connection). Network 116 can be the same as, or different than, network 114.

In some embodiments, the medical documentation system 100 includes a medical documentation platform 102 that is stored locally (e.g., as a set of machine-readable software instructions on an electronic device) on an electronic device, such as electronic devices 110a-c. More specifically, medical documentation platform 102 can be software—including algorithms, modules, and specialized components—that runs on a user-controlled device as shown in FIG. 1. In such embodiments, the user may be able to specify how often data is retrieved from the source(s) of medical information 106a-n, how often statistical models are applied or reports are generated, etc. In some embodiments, the medical documentation platform 102 can be located in a separate database (e.g., connected to an electronic device 110a-c via the network), and the electronic device can call or query the medical documentation platform 102. The medical documentation platform 102 is described in more detail in FIG. 2 below.

### Medical Documentation Platform

FIG. 2 is a generalized block diagram illustrating a medical documentation platform 102 in accordance with some implementations of the present disclosure. FIG. 2 is also an example of the medical documentation platform 102 of FIG. 1 in more detail. As shown in FIG. 2, the medical documentation platform 102 can include one or more central processing units (CPU) 205 for executing a software 215 stored in memory 210.

Memory 210 stores software 215, which can include a risk calculator 220, a record finder 225, a model analyzer 230, a report generator 235, and a GUI generator 240. The risk calculator 220, record finder 225, model analyzer 230, report generator 235, and the GUI generator 240 can perform certain methods or functions of the medical device platform 102 described below. Memory 210 can also include components, subcomponents, or other logical entities that assist with or enable the performance of some or all of these methods or functions. While not shown in FIG. 2, in some embodiments, the risk calculator 220, the record finder 225, the model analyzer 230, the report generator 235, and the GUI generator 245 can comprise any combination of software agents and/or hardware components.

The risk calculator 220 can compute inputs (e.g., risk variables) for evidence-based models. The risk calculator 220 may comprise any combination of software agents and/or hardware components. The risk calculator 220 can track associations between risk variables, a diagnosis, and evidence-based models. For example, a risk calculator 220 can determine the inputs (e.g., age, gender, race) for evidence-based models (e.g., IMPROVE Heart Failure, OPTIMIZE Heart Failure). With the inputs, the risk calculator 220 can compute the expected or predicted outcome for an evidence-based model. For example, the risk calculator 220 can receive patient data from the record finder 225, and then the risk calculator 220 computes that the patient has an 85% probability of mortality based on the evidence-based model and patient data.

In general, the risk calculator assess the electronic medical record data for a patient source for several evidence based models. Each of these models can have a mean risk and includes definitions of low- and high-risk outcomes. Because the models are based on logistic regression with beta and alpha values, the risk calculator can recreate the model and link to patient EHR data that has been imported via the medical documentation system (see FIG. 1). The risk calculator can compute the output (e.g., predictive results) for several evidence-based models concurrently. In some embodiments, the risk calculator can compute a score (e.g., a score from an evidence-based model), which can be displayed for a user. In some embodiments, the risk calculator can compute a probability of an outcome (e.g., probability of mortality after hospital visit for heart failure based on an evidence-based risk model), which can be displayed for a user. The risk calculator can compute scores or probable outcomes for several models, which can be provided to a user. The risk calculator 220 can communicate with the record finder 225, the model analyzer 230, the report generator 235, and the GUI generator 240.

The record finder 225 retrieves patient data. The record finder 225 may comprise any combination of software agents and/or hardware components able to receive, process, and update data from advertising networks, advertisers, or other sources. For example, the record finder 225 can retrieve demographic information (e.g., age, weight, height) for a patient from an electronic medical record (e.g., medical information source 106a or storage database 104). The record finder 225 can retrieve a medical record in response to receiving a request from a user at GUI 108. Also, the record finder can retrieve data from a medical record in response to receiving a request from the risk calculator 220. The record finder 225 can communicate with the risk calculator 220, the model analyzer 230, the report generator 235, and the GUI generator 240.

The model analyzer 230 analyzes outputs of evidence-based models. The model analyzer 230 also communicates with the risk calculator 220 to compute outputs for variables in evidence-based models. The model analyzer 230 may comprise any combination of software agents and/or hardware components. The model analyzer 230 can communicate with the risk calculator 220, record finder 225, report generator 235, and the GUI generator 240.

A GUI generator 240 can generate a GUI that allows a user (e.g., doctor, administrator, nurse, billing agent, medical school student, assistant, etc.) to interact with the medical documentation platform 102. In some embodiments, a GUI is presented to the user by a web application or web-based portal, a web browser, a mobile application adapted for a cellular device, a PDA, a tablet, a personal computer, etc. For example, a user can select a patient, select a diagnosis, adjust variables for a report, and request to process a report via a GUI. The GUI generator 240 can communicate with the risk calculator 220, record finder 225, model analyzer 230, and report generator 235.

As shown in FIG. 2, the medical documentation system 100 can access many datasets, namely evidence-based models database 109 and storage database 104. These datasets are accessible by the risk calculator 220, record finder 225, model analyzer 230, report generator 235, and GUI generator 240 described above, and these components can store information in these datasets or update information in these datasets continuously, periodically, or sporadically. Also, while not shown in FIG. 2, the medical documentation platform 102 can include a compliance engine. A compliance engine can retrieve, analyze, and report medical compliance data. For example, the compliance engine can query a Hospital Compare Medicare database.

Evidence-based models database 109 includes information about evidence-based models, risk variables, and related literature. Evidence-based medical (EBM) models are a systematic approach to clinical problem solving which allow the integration of the best available research evidence with clinical expertise and patient values. For example, one well known EBM is “IMPROVE HEART FAILURE (HF): a prospective study involving more than 40,000 patients treated at over 160 cardiology practices in the United States,” which seeks to identify gaps in outpatient heart failure care and help clinicians implement strategies to improve the use of evidence-based therapies. IMPROVE HF focuses on the following conditions: congestive heart failure, myocardial infarction, and left ventricular dysfunction. More information can be found at www.clinicaltrials.gov, which is incorporated in its entirety in this patent application.

Datasets in evidence-based models database 109 can include input variables for the evidence-based models (also referred to as “risk variables”), conclusions of evidence-based models (also referred to as “outcomes”), and links (e.g., a hyperlink to the World Wide Web with literature for IMPROVE HF) to supporting literature for the evidence-based models. An administrator of the evidence-based models database 109 can adjust the inputs, conclusions, and links for based on updated information or to more accurately reflect developments in medicine.

As an example of a database 109, evidence-based models database 109 can store risk variables, conclusions, and hyperlinks for IMPROVE HF. For example, IMPROVE HF includes risk variables for age, gender, dosage of β-Blockers, HF education, and anticoagulation for atrial fibrillation. IMPROVE HF concludes that β-Blocker and cardiac resynchronization therapy were associated with the greatest 24-month survival benefit (adjusted odds ratio for death 0.42, 95% confidence interval (CI), 0.34-0.52; and 0.44, 95% CI, 0.29-0.67, respectively); angiotensin-converting enzyme inhibitors/angiotensin receptor blockers, implantable cardioverter-defibrillators, anticoagulation for atrial fibrillation, and HF education were also associated with benefit, whereas aldosterone antagonist use was not.

Evidence-based models database 109 can store many (e.g., hundreds, thousands) evidence-based models in the database, as well as additions and modifications to the models, and each input (e.g., risk variable) for the evidence-based models in an organized data structure. More details regarding how evidence-based models are stored and input into the evidence-based models database 109 are described in FIG. 3. For example, evidence-based models database 109 can store EBM for diabetes, heat stroke, fractured bones, strokes, brain injuries, and the like. An administrator or owner of evidence-based models database 109 can add evidence-based models, delete evidence-based models, and make additions or modifications. For example, a team of doctors can look at a particular model (e.g., IMPROVE HF) and can determine that certain conclusions are useful for patients admitted to the hospital and for supporting appeals for denied claims. Also, administrators or owners of the database can modify evidence-based models in the database to include or not include certain inputs. For example, a doctor can determine that Na concentration in a evidence-based model is not useful in the evidence-based model and can delete it as a risk variable. Furthermore, evidence-based models database 109 can store formulas and methods for calculating an outcome of an evidence-based model for a particular set of risk variables. For example, creatinine clearance is a recognized “risk factor” in some predictive models, and it can be calculated from six variables: age, gender, race, serum creatinine, height, and weight. Additionally, the evidence-based models can be organized according to common risk variables or according to International Code for Disease 9 (ICD-9) or ICD-10.

In general, collaborative research organizations, consortiums of health care organizations, or registries can generate predictive models that can be based upon huge populations of patients with the same diagnosis and input into evidence-based models database 109. For example, the ACC-NCDR (American College of Cardiology—National Cardiovascular Database Registry) sponsors the CathPCI registry, which includes several evidence-based model databases. The ACC-NCDR, together with the American Hospital Association (AHA), sponsors the ACTION-GWTG (Acute Coronary Treatment and Intervention Outcomes Network registry—Get with the Guidelines, another evidence-based model). Also, the evidence-based models are generally predictive statistical models that can be derived from logistic regression or hazard function/survival analysis models, and the published literature can provide the actual statistical model complete with β-coefficients or may provide an abbreviated logistic regression model or an additive nomogram model patterned off the logistic regression model. Below in Table 1 and Table 2 are some examples of evidence-based models, but after reading this disclosure, one with ordinary skill in the art will appreciate how to integrate evidence based models for other medical issues (e.g., back pain, broken bones, diabetes, brain injury, dermatological conditions, and the like).

For example, Acute Heart Failure Syndrome (AHFS) evidence based statistical models (see table below): can include several separate logistic regression and additive nomogram statistical risk models that are predictive of in-hospital and short-term mortality, hospital length of stay (LOS), and other adverse events up to and including 30-day readmission and 30-day mortality. Each of these models is based on the input from approximately 20 data elements collected from an electronic medical record. Risk calculation of individual patients is based on a score tabulated on the totality of risk rules for all AHFS variables that are populated with data. In addition, a portion of the score is based upon a collection of predictive statistical risk models that predict mortality, adverse events, and/or readmission related for AHFS during hospitalization, at 30-days following hospitalization, and/or annually.

TABLE 1
Example of Statistical Models for AHFS

| | |
|---|---|
| GWTG-HF | The AHA-sponsored “Get with the Guidelines Heart Failure” model for |
| | acute decompensated heart failure is based on 7 inputs/risk |
| | factors: systolic BP, BUN, Sodium (Na), age, heart rate, race, and |
| | COPD with data from 46,532 patients in 202 hospitals and a C- |
| | statistic = 0.75. |
| ADHERE | The Acute Decompensated Heart Failure National Registry of |
| | patients with acute decompensated heart failure model is based on |
| | an analysis of 65,275 patients in 263 US hospitals, inputs/variables |
| | include: age, systolic BP, BUN, and heart rate. |
| OPTIMIZE-HF | The Organized Program to Initiate Lifesaving Treatment in |
| | Hospitalized Patients with Heart Failure is a registry/performance |
| | model for patients hospitalized with HF in 259 U.S. hospitals The |
| | model includes inputs for: age, systolic BP, heart rate, sodium (na), |
| | creatinine, and LVSD (LVEF <=40%). |
| EHMRG: | The Emergency Heart Failure Mortality Risk Grade 7-day mortality |
| | risk score is a Canadian funded study of 12,591 patients presenting |
| | to the ED for treatment of heart failure in 86 hospitals in Ontario, |
| | Canada. 10 highly predictive inputs/risk factors: ED evaluation, |
| | age, EMS transport to ED, systolic BP, heart rate, SpO2, creatinine, |
| | potassium (K), abnormal troponin, cancer (active), Metolazone Use. |
| EFFECT: | The Enhanced Feedback for Effective Cardiac Treatment (EFFECT) |
| | study reported all-cause 30-day and 1-year mortality on 4,031 |
| | community-based patient presenting at 34 hospitals in Ontario, |
| | Canada. Includes predictions for 30-day mortality and 1-year |
| | mortality from several inputs (e.g., age). |

As another example, evidence based models for patients who present to the hospital with chest pain/MI (myocardial infarction)/Acute Coronary Syndrome (ACS) can include clinical scenario groups: both types of MI, (STEMI and NSTEMI) and Unstable Angina (USA), an unstable form of coronary artery disease that is a precursor to MI. The risk calculator can use these evidence-based models to predictive/assess risk among the multiple sub-categories of ACS patients. The following is a table with a partial list of statistical predictive evidence based models utilized in the Chest Pain/ACS:

TABLE 2
Evidence-based models for chest pain

| | |
|---|---|
| GRACE | The Global Registry of Acute Coronary Events can include 8 |
| | different statistical logistic regression and nomogram score risk |
| | models that predict in-hospital and post-discharge outcomes |
| | including mortality, recurrent MI, and other adverse events using 6 |
| | to 12 inputs from the medical record: age, ACS Type, cardiac |
| | arrest, heart rate, systolic BP, Killip score for heart failure, |
| | creatinine, Abnormal Troponin-I/T, Myoglobin, CK-MB, EKG-ST |
| | Segment Deviation. The model was developed from 94 hospitals in |
| | 14 countries that measures in-hospital mortality associated with ACS |
| | hospitalization. |
| SYNERGY | The SYNERGY trial tested Enoxaparin vs. Heparin in high-risk |
| | patients with ACS in 467 heart centers in 12 countries. A predictive statistic |
| | model evaluated peri-hospital and 1-year mortality using |
| | multiple admission input variables: age, gender, type of ACS, |
| | CABG surgery, statin Use, height, weight, hemoglobin, platelet |
| | count, creatinine, and atrial fibrillation. |
| PURSUIT | The Platelet Glycoprotein IIb/IIIa with Eptifibatide in Patients with |
| | Acute Coronary Syndromes Trial evaluated nearly 11,000 patients |
| | presenting with ACS at multiple heart centers that evaluated the |
| | value of eptibibatide, a platelet inhibitor. A logistic regression 30- |
| | day mortality predictive model was developed using 24 predictive |
| | variables such as: age, gender, CCS Class, ACS Type, |
| | hypertension, diabetes, prior heart failure, prior CABG, tobacco use, |
| | beta-blocker use, Ca-channel blocker use, nitrates, G2b3a inhibitor |
| | use, height, weight, systolic BP, Killip class of heart failure, EKG |
| | ST-segment depression, and time to symptom onset to treatment. |

Storage database 104 can store related information for the medical documentation platform 102. For example, storage database 104 can store medical literature that is associated with particular evidence-based models. Storage database 104 can also store EHR or EMR for patients. Storage database 104 can also store letters generated by the medical documentation platform 102.

FIG. 3 is a flow diagram illustrating an example of a set of operations for using evidence-based models and patient data to generate and display predictive analysis for patients. As a broad overview, FIG. 3 demonstrates process 300 for how a doctor or administrator can use an electronic device to implement the medical documentation platform 102 to analyze a diagnosis for a patient based on evidence-based models. Process 300 begins at operation 310 and continues to operation 320.

At operation 310, a user of the medical documentation platform 102 selects a patient to analyze. For example, a doctor in an emergency room or a hospital administrator selects a patient from a graphical user interface or enters in a patient's name via the graphical user interface. In response to the patient selection, the medical documentation platform 102 can retrieve the patient's medical record data (e.g., from a EHR or EMR). The medical documentation platform 102 can present the patient data such as the patient's diagnostic symptoms, medical history, and demographic information. Also, the medical documentation platform 102 can receive a diagnosis from the doctor or determine a previous diagnosis in the record. For example, a hospital administrator can enter in “heart attack” or an ICD-9 or ICD-10 code for a patient.

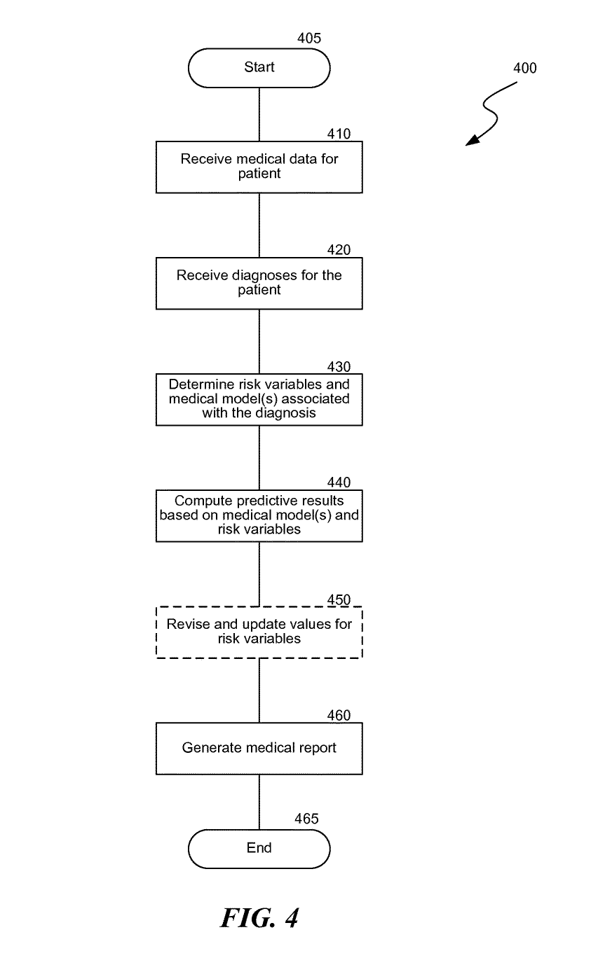

At operation 320, the medical documentation platform 102 generates predictive analysis. Predictive analysis can be based on the output of evidence-based models (e.g., the evidence-based models stored in database 104). At operation 330, the medical documentation platform 102 can display the results for each evidence-based model for the patient based on the patient's diagnosis and data. The predictive analysis can include: length of stay and for risk of re-admission. More detail related to the predictive analysis is described in FIG. 4.

At operation 340, a user can generate more supporting data based on the predictive analysis from operation 320. For example, a user can view the current status of a patient (e.g., months or years after a predictive analysis) to supplement databases and generate a stronger model. Also, a user can add notes or make changes to evidence-based models. Iterative data entry for new data permits an updated analysis and further reassessment by the hospital and medical care team. This iterative process may be repeated without limit, but it is anticipated that the process will be dictated by new data and the patient's response to medical care.

FIG. 4 is a flow diagram illustrating an overview of a process for generating a medical report based on evidence-based models in accordance with some implementations of the present disclosure. Process 400 begins at operation 405 and continues to operation 410. In some implementations, process 400 can be performed in response to a doctor requesting to generate a report for a patient. In some implementations, process 400 can be performed in response to a request from a Medicare representative requesting more information to review a medical claim. In some implementations, process 400 can be performed in response to an emergency room doctor requesting to generate a report for a patient in an emergency room (e.g., a patient who recently suffered a heart attack). In some implementations, process 400 can be performed in response to a hospital administrator requesting to generate a report in response to denied claim. In general, a user can request to initiate process 400 before, after, or during a patient's visit to a hospital. Also, a user can repeat process 400 for several patients.

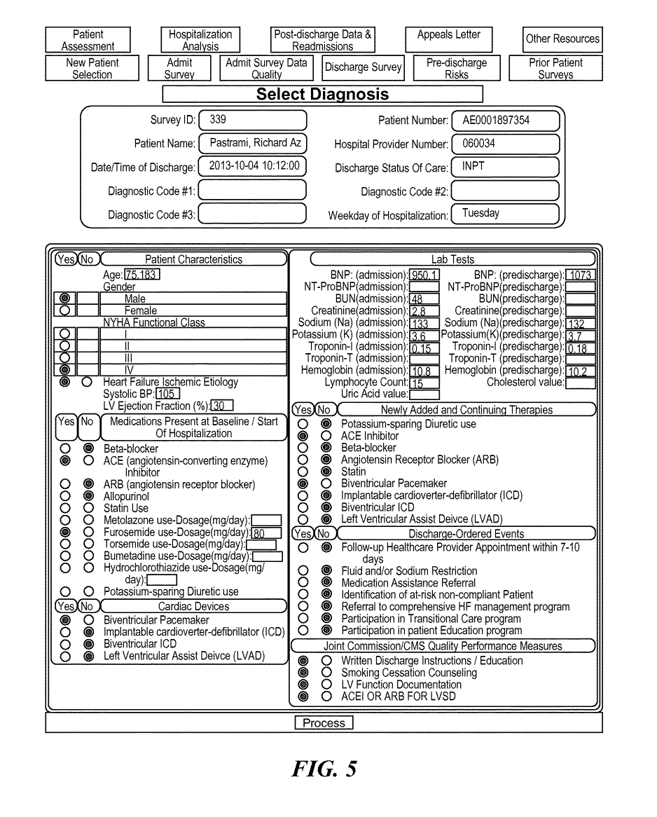

At operation 410, a medical documentation platform 102 receives medical data for a patient. For example, a user via GUI 108 can request to analyze evidence-based models for a diagnosis for a patient. The user can enter the patient's name or identification number into the GUI, and the medical documentation system 100 can retrieve the patient's medical record. In some implementations, the record finder 225 can retrieve a patient's electronic medical record from a medical information source 106a-n or storage database 104. Once the medical documentation platform 102 receives the patient data, the medical documentation platform 102 can display the patient data via the GUI (e.g., GUI 108 from FIG. 1). An example of the GUI can be seen in FIG. 5.

At operation 420, a medical documentation platform 102 receives a diagnosis for the patient. For example, a user of electronic device (e.g., 112a-112c in FIG. 1) can enter in heart attack as the diagnosis via the GUI (e.g., GUI 108 in FIG. 1). As another example, a hospital administrator can enter in a diagnosis in response to a letter that denied payment for the hospital's medical claim related to the diagnosis. At operation 430, a medical documentation platform 102 determines risk variables and medical model(s) associated with the diagnosis from operation 420.

At operation 440, a medical documentation platform 102 computes predictive results based on medical model(s) and risk variables from operation 430. In operation 410 and 420, the medical documentation platform 102 received the information (e.g., patient data and diagnosis) to input values into an evidence-based model (or evidence-based models) to compute predictive outcomes. For example, a hospital administrator can request to receive predictive results for a patient who recently was diagnosed with a heart attack. The medical documentation platform 102 receives this request and enters the inputs (e.g., risk variables) into a few evidence-based models (e.g., IMPROVE HF). The medical documentation platform 102 outputs predictive results for the patient based on the model. For example, the medical documentation platform 102 can output a result that the patient has a 95% of mortality based on his age and recent heart attack. The medical documentation can also include a link to the evidence-based models and supporting literature for this conclusion.

At operation 450, a medical documentation platform 102 can revise and update values for risk variables. Operation 450 is an optional operation (as shown by the dashed lines in FIG. 4). For example, a nurse can update the cholesterol data for a patient, and the medical documentation platform 102 can compute the outcome of an evidence-based model again based on the updated cholesterol data. As described below, some risk variables (inputs) are more significant than others. Thus, inclusion or exclusion of the variable in computation of the evidence-based model can significantly change the predictive results. For example, a high cholesterol value in some evidence-based models can greatly increase the probability of mortality within 3 months, which may alert a doctor or hospital administrator to adjust or compensate for the level of care provided.

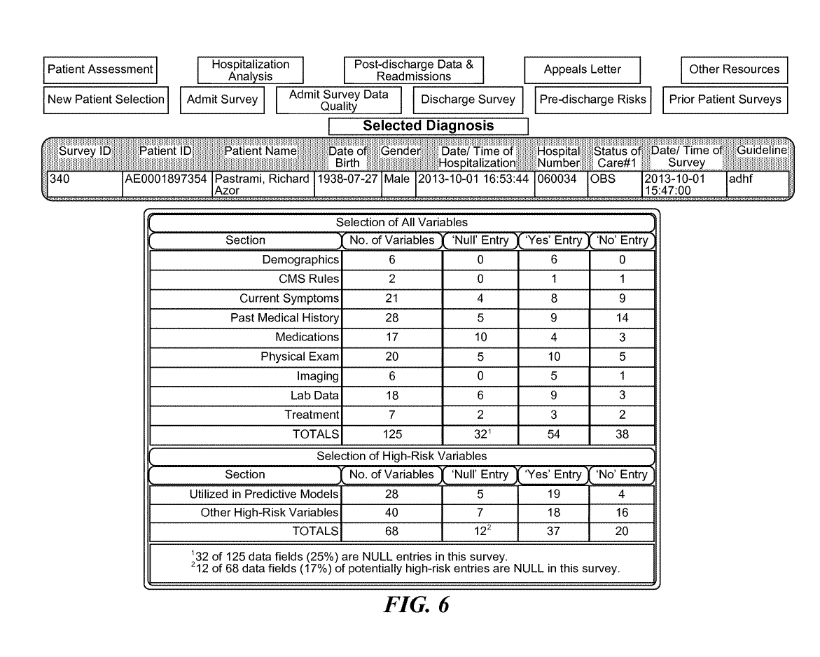

At operation 460, process 400 generates a medical report. As described in more detail in FIGS. 6-9, the medical documentation platform 102 can display a report with predictive results for the patient. For example, GUI 108 can provide predictive risks for a selected patient according to seven published, evidence-based models for mortality associated with acute heart failure syndrome. The mortality models provide predictions for in-hospital mortality, 7-day mortality, 30-day mortality, and 1-year-mortality, and the models are based on as few as four and as many as 11 of the most-highly predictive variables that were utilized in multivariable logistic regression models. All of these models were based on large numbers of patients and have good statistical discrimination (C-statistics between 0.72 and 0.86) and good calibration. Also, an user of the medical documentation platform 102 can view supporting literature for each study via a GUI (e.g., GUI 108 on an electronic device). After operation 460, process 400 proceeds to operation 465 where it ends. For example, a user can close the medical documentation platform 102 and turn off the electronic device running the medical documentation platform 102.

### Exemplary GUIs

FIGS. 5-8 are screenshots of graphical user interfaces (GUIs) in accordance with some implementations of the present disclosure. FIG. 5 is an example of a home screen a user of the medical documentation platform 102 can view when interacting with the platform. At the top of the GUI, a user can select or toggle buttons, such as a “New Patient Selection,” or an “Admit Survey”. Each of these buttons can open a new window or display new objects in a GUI. A user can interface with a GUI via touching (e.g., a touch screen), a keyword (e.g., entering in text), or a mouse. FIG. 5 can be an admit screen for a patient that is being seen in an emergency room by a doctor (e.g., patient Pastrai, Richard with patient number AE0001897354). As shown in FIG. 5, the GUI can display data from a patient's medical record such as sodium levels or what type of therapies the patient is currently using. Also, a user can select a diagnosis (e.g., acute heart failure, migraine, broken bone) that he or she wants to analyze for a given patient. Selecting a diagnosis can link the evidence-based models and risk variables associated with the symptom diagnosis.

FIG. 6 is a GUI displaying an analysis of variables (e.g., risk variables or inputs) for an evidence-based model. For example, for the selected diagnosis, a user can see that there are six variables for demographics (e.g., age, gender, race, height, weight, etc.) and there are “0” null entries. A null entry indicates that there is no value for the variable (e.g., no blood pressure information), but the variable is used in the evidence-based model (e.g., acute heart failure). Null variables can alert a user to accuracy or persuasiveness of conclusion supplied by a model.

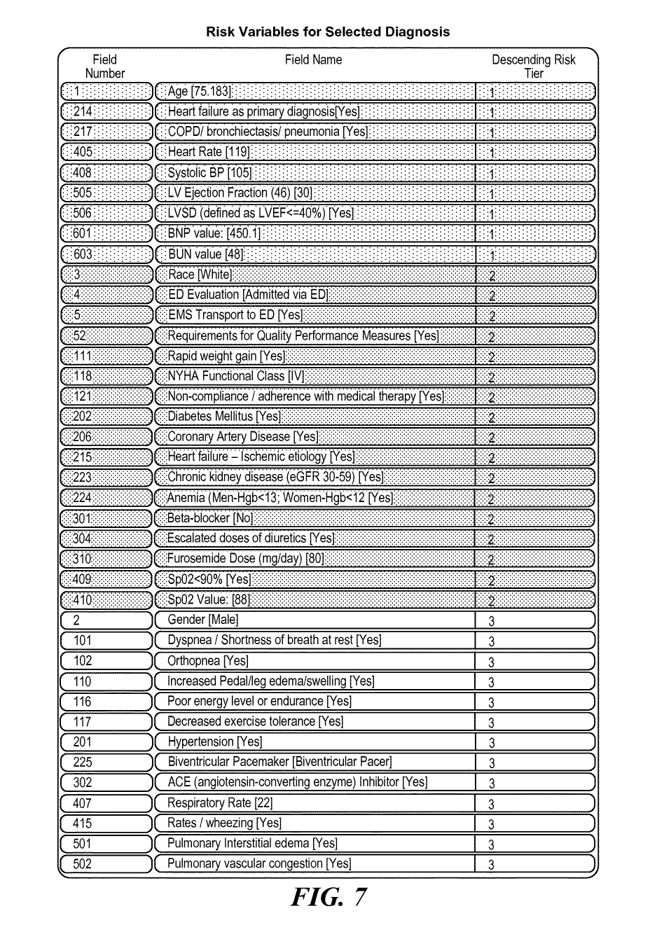

FIG. 7 is a GUI displaying a list of variables for a selected diagnosis and corresponding tier. As shown in FIG. 7, each row can include a variable number, a variable name, and an associated value of the variable. In some embodiments, variables have tiers (e.g., tier 1, tier 2, tier 3, etc.). For example, tier 1 variables can be high-risk characteristics associated with acute heart failure syndrome (AHFS) such that it has been identified as the most predictive of variables in statistical models for in-hospital mortality and other adverse outcomes. Tier 2 variables can be high-risk characteristics associated with AHFS that have been identified to have high statistical association with in-hospital mortality, increased length of stay, and other adverse outcomes in evidence-based literature. Tier 3 variables can represent a moderate-risk and/or high-risk characteristic with documented univariate statistical relationship to AHFS. However, the value of tier 3 variables may not represent a high-risk and/or may be strongly supportive for medical necessity but may not in itself pose an increased risk of mortality nor increase support for length of stay or readmissions considerations. Tier 4 variables can be low-risk to moderate-risk characteristics for AHFS due to a low-risk value or with no apparent risk relationship with AHFS. Examples of the values and risk variables are shown in FIG. 7. Similarly, one with ordinary skill in the art will appreciate with this disclosure that other medical syndromes (e.g., diabetes) can have risk variables calculated by a group or doctors or researchers.

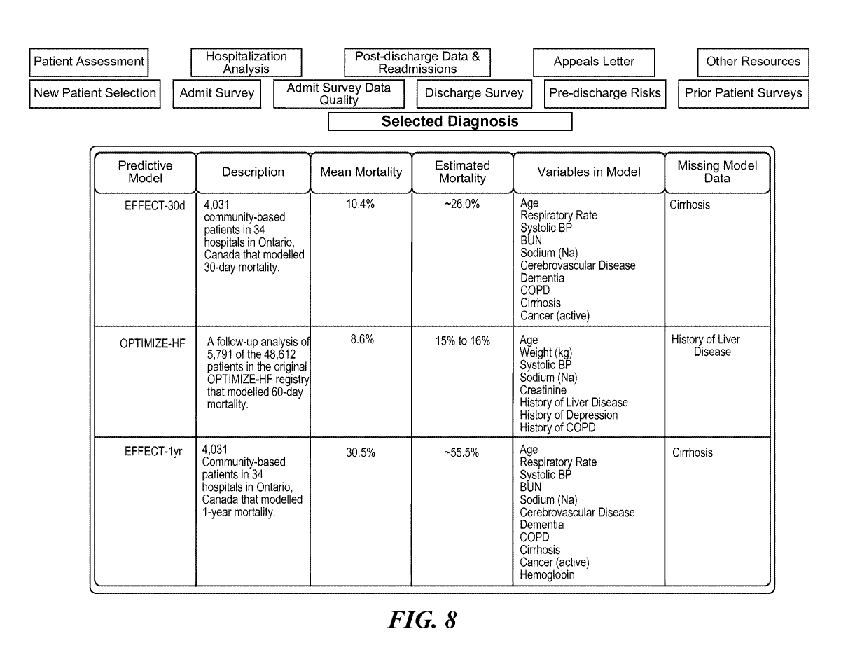

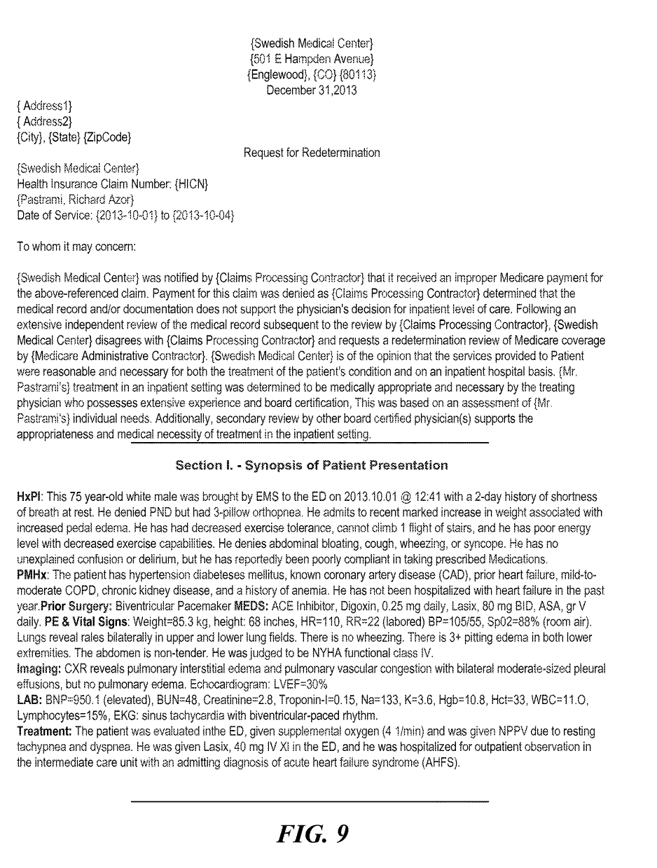

FIG. 8 is a GUI displaying outputs or predictive statistical results for a variety of evidence-based models. For example, the GUI is displaying results for the following models: EFFECT-30d, OPTIMIZE-HF, EFFECT-1yr. The GUI can include a description of the evidence-based model used and some statistical results for the model form. A user can select the post-discharge data and readmission button to display the GUI shown in FIG. 9.

### Letter

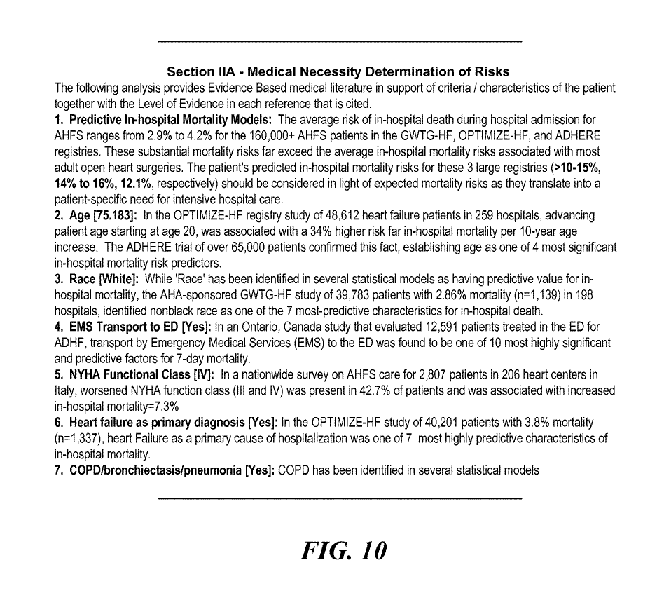

FIG. 9 and FIG. 10 are an example of a letter generated by the medical documentation platform 102 in accordance with some implementations of the present disclosure. In some embodiments, the medical documentation platform 102 generates a letter in response to receiving a request from a hospital administrator via a GUI for clinical documentation to support the level of care provided to a patient. For example, a hospital administrator can request a letter via a GUI to support an appeal for a medical denial claim. In response, the medical documentation platform 102 can generate a letter with data fields that are automatically populated from evidence-based models used to determine and support level of care and from medical literature (e.g., quotes from the supporting literature for the medical models). See FIG. 10. The letter text can include variables that address the medical necessity for care as demonstrated by the increased risk of adverse events and in-hospital mortality associated evidence-based models. The letter can include variables that address the estimated hospitalization length of stay for care for this patient with a particular diagnosis (e.g., acute heart failure) and factors for re-admissions-related issues associated with this patient's presentation with this episode of care. Furthermore, the letter can recite particular data from the patient's electronic medical record, for example, the patient's blood pressure at the time of admission and a quote from a evidence-based model that explains the patient's blood pressure exceeded a high level of risk for morality based on the evidence-based model.

In general, the letter provides a party with significant and relevant documentation for the patient, and the hospital can choose what data they desire to include in the letter if they choose to use it as their redetermination appeals letter. Most importantly, the medical documentation platform 102 tool provides these analyses as part of the clinical documentation, and these data are available in real time for incorporation into the medical record at the time of the patient's hospitalization. Placement of this clinical documentation into the medical record at the time of hospitalization would likely provide strong evidence to mitigate any claim denial and need for an appeal.

### Exemplary Computer System Overview

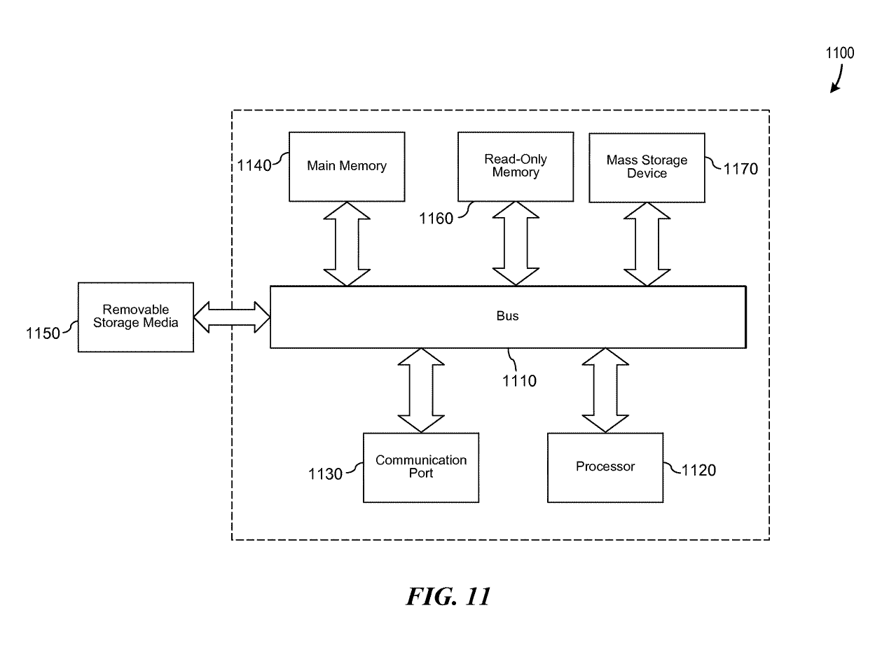

FIG. 11 is a block diagram illustrating an example of a computing system in which at least some operations described herein can be implemented. A variety of these steps and operations described above can be performed by hardware components or may be embodied in machine-executable instructions, which may be used to cause a general-purpose or special-purpose processor programmed with the instructions to perform the steps. Alternatively, the steps may be performed by a combination of hardware, software, and/or firmware. As such, FIG. 11 is a block diagram illustrating an example of a computing system in which at least some operations described herein can be implemented. According to the present example, the computer system includes a bus 1110, at least one processor 1120, at least one communication port 1130, a main memory 1140, a removable storage media 1150, a read-only memory 1160, and a mass storage device 1170.

Processor(s) 1120 can be any known processor, such as, but not limited to, Intel® lines of processors, AMD® lines of processors, or Motorola® lines of processors. Communication port(s) 1130 can be any of an RS-232 port for use with a modem-based dialup connection, a 10/100 Ethernet port, or a Gigabit port using copper or fiber. Communication port(s) 1130 may be chosen depending on a network such as a Local Area Network (LAN), Wide Area Network (WAN), or any network to which the computer system 1100 connects.

Main memory 1140 can be random access memory (RAM) or any other dynamic storage device(s) commonly known in the art. Read-only memory 1160 can be any static storage device(s) such as programmable read-only memory (PROM) chips for storing static information such as instructions for processor(s) 1120.

Mass storage device 1170 can be used to store information and instructions. For example, hard disks such as the Adaptec® family of SCSI drives, an optical disc, an array of disks such as RAID (such as the Adaptec family of RAID drives), or any other mass storage devices may be used.

Bus 1110 communicatively couples processor(s) 1120 with the other memory, storage and communication blocks. Bus 1110 can be a PCI/PCI-X or SCSI based system bus depending on the storage devices used.

Removable storage media 1150 can be any kind of external hard drives, floppy drives, IOMEGA® Zip Drives, compact disc-read-only memory (CD-ROM), compact disc-re-writable (CD-RW), and/or digital video disk-read only memory (DVD-ROM).

The components described above are meant to exemplify some types of possibilities. In no way should the aforementioned examples limit the scope of the disclosure, as they are only exemplary implementations.

Various modifications and additions can be made to the implementations discussed without departing from the scope of the present disclosure. For example, while the implementations described above refer to particular features, the scope of this disclosure also includes implementations having different combinations of features and implementations that do not include all of the described features. Accordingly, the scope of the present disclosure is intended to embrace all such alternatives, modifications, and variations and all equivalents thereof.

As used herein, the word “or” refers to any possible permutation of a set of items. For example, the phrase “A, B, or C” refers to at least one of A, B, C, or any combination thereof, such as any of: A; B; C; A and B; A and C; B and C; A, B, and C; or multiples of any item such as A and A; B, B, and C; A, A, B, C, and C; etc.

What is claimed is:

1. A method for processing medical data and generating a patient-specific risk assessment for a medical diagnosis, the method comprising:
receiving, via a graphical user interface on an electronic device, a selection for a patient;
in response to receiving the selection for the patient, automatically retrieving electronic medical record data for the patient from a medical information server;
receiving, via the graphical user interface, a diagnosis for the patient;
identifying statistical medical models that correspond with the diagnosis,
based on the diagnosis, the electronic medical record data, and the statistical medical models, generating a list of risk variables and at least some values associated the risk variables;
based on the values associated with the risk variables, computing an outcome for at least some of the statistical medical models;
receiving, via the graphical user interface, an instruction to generate a patient-specific risk assessment;
based on the risk variables and the values associated with the risk variables, generating the patient-specific medical risk assessment, wherein the assessment includes:
predictive medical information, expected length of stay, and risk of readmission for the patient.

2. The method of claim 1, further comprising:
based on the diagnosis and the electronic medical record data, generating a list of null variables, wherein null variables indicate risk variables that do not have an associated value.

3. The method of claim 2, wherein generating the patient-specific medical risk assessment includes warning the user that results of the report may be inaccurate because of the null variables.

4. The method of claim 1, further comprising:
generating a medical evidence letter that includes at least a portion of the patient-specific medical risk assessment,
wherein the letter is support documentation for rebutting a medical claim denial.

5. The method of claim 1, wherein the evidence-based models are derived from logistic regression or hazard analysis models.

6. The method of claim 1, further comprising:
receiving updated or revised values for at least some of the risk variables; and
generating a new patient-specific medical risk assessment based on the updated or revised values.

7. The method of claim 1, further comprising:
identifying a different diagnosis medically related to the diagnosis; and
generating a new patient-specific medical risk assessment based on risk variables associated with the different diagnosis.

8. A computer-readable storage medium, excluding transitory signals, containing instructions that, when executed by one or more processors, perform a method for producing a medical report, the method comprising:
receiving, via a graphical user interface on an electronic device, a selection for a patient;
in response to receiving the selection for the patient, automatically retrieving electronic medical record data for the patient;
receiving, via the graphical user interface, a diagnosis for the patient;
identifying statistical medical models that correspond with the diagnosis,
based on the diagnosis, the electronic medical record data, and the statistical medical models, generating a list of risk variables and at least some values associated the risk variables;
based on the values associated with the risk variables, computing an outcome for at least some of the statistical medical models;
receiving, via the graphical user interface, an instruction to generate a patient-specific risk assessment;
based on the risk variables and the values associated with the risk variables, generating the patient-specific medical risk assessment, wherein the assessment includes:
predictive medical information, expected length of stay, and risk of readmission for the patient.

9. The computer-readable storage medium of claim 8, wherein the method further comprises:
based on the diagnosis and the electronic medical record data, generating a list of null variables, wherein null variables indicate risk variables that do not have an associated value.

10. The computer-readable storage medium of claim 8, wherein the method further comprises:
based on the diagnosis, ranking the risk variables into three tiers, where the first tier are most influential variables in a model, the second tier are influential variables in the model, and the third tier are minimally influential variables in the model.

11. The computer-readable storage medium of claim 10, wherein the generating the patient-specific medical risk assessment is only based on the first and second tier of risk variables.

12. The computer-readable storage medium of claim 8, wherein the patient-specific medical risk assessment also includes a recommendation to comply with healthcare standards.

13. The computer-readable storage medium of claim 8, wherein the method further comprises:
receiving, via the graphical user interface, updated or revised associated values for at least some of the risk variables.

14. A system for generating a medical report, the system comprising:
one or more processors;
a memory storing instructions for a record finder, a risk calculator, and a report generator, wherein:
the record finder is configured to:
retrieve medical data for a patient;
retrieve a diagnosis for the patient or request from a user the diagnosis for the patient;
receive medical data for the patient from a user;
the risk calculator is configured to:
determine risk variables associated with the diagnosis based on evidence-based medical models for the diagnosis;
compute an associated risk value for at least some of the risk variables;
the report generator is configured to:
generate a patient-specific medical report for the patient based on the diagnosis and the associated risk values; and
transmit a recommendation for level of care for the patient.

15. The system of claim 14, wherein the memory further comprises instructions for:
a graphical user interface (GUI) generator configured to:
display a GUI with the patient-specific risk assessment; and
receive updated risk variables from a user.

16. The system of claim 14, wherein the memory further comprises instructions for:
a compliance engine configured to:
determine whether the recommendation for level of care for the patient is in compliance with health regulations.

17. The system of claim 14, wherein the risk calculator is further configured to:
query a database of evidence-based models that includes predictive information for medical necessity and length of stay and for risk of readmission for selected diagnoses.

18. The system of claim 17, wherein the evidence-based models are derived from logistic regression or hazard function/survival analysis models.

19. The system of claim 14, wherein the patient-specific medical report includes predictive results for the patient based on at least two evidence-based models and at least a portion of medical literature supporting the predictive results.

20. The system of claim 14, wherein the instructions are configured to be executed by a mobile electronic device.
